(19) United States
(12) Patent Application Publication
(10) Pub. No.: US 2014/0349200 A1
(43) Pub. Date: Nov. 27, 2014

(54) METHOD FOR DECOMPOSING AND PURIFYING BIOMASS, ORGANIC MATERIAL OR INORGANIC MATERIAL WITH HIGH EFFICIENCY AND SIMULTANEOUSLY GENERATING ELECTRICITY AND PRODUCING HYDROGEN, AND DIRECT BIOMASS, ORGANIC MATERIAL OR INORGANIC MATERIAL FUEL CELL FOR SAID METHOD

(71) Applicant: The Institute of Biophotochemonics Co. Ltd, Mito-shi, Ibaraki (JP)

(72) Inventors: Masao Kaneko, Mito-shi (JP); Hirohito Ueno, Mito-shi (JP); Junichi Nemoto, Mito-shi (JP); Yuki Fujii, Mito-shi (JP)

(73) Assignee: The Institute of Biophotochemonics Co., Ltd, Mito-shi, Ibaraki (JP)

(21) Appl. No.: 14/362,837

(22) PCT Filed: Nov. 30, 2012
(86) PCT No.: PCT/JP2012/081121

§ 371 Date: Jun. 4, 2014

(30) Foreign Application Priority Data
Dec. 6, 2011 (JP) 2011-267263

(51) Int. Cl. H01M 8/04; H01M 8/22

(52) U.S. Cl. CPC H01M 8/04186; H01M 8/22
USPC 429/410

(57) ABSTRACT

[TECHNICAL PROBLEM]

The present invention relates to a method for highly efficiently decomposing and purifying biomass, organic/inorganic compounds, waste, waste fluids, and environmental pollutants, by harnessing a catalyst action without applying any light, and simultaneously generate electricity.

[SOLUTION TO PROBLEM]

In the invention, first provided a composite three-layered anode which has a constitution of conductive electrode base layer, porous semiconductor layer, and catalyst layer, and then immersed the composite anode in a liquid phase such as an aqueous solution or suspension that contains as the fuel at least one of or a mixture of biomass, biomass waste, and organic/inorganic compounds, and a counter cathode is disposed for oxygen reduction in the liquid phase, and oxygen is supplied into the liquid phase and thereby conducted the fuel cell reaction and the fuel is decomposed and electricity is generated without applying external energy.

### TECHNICAL FIELD

The present invention relates to a method for highly efficiently decomposing and purifying biomass, organic/inorganic compounds, waste, waste fluids, environmental pollutants, etc., harnessing a catalyst action without applying or irradiating any light thereto, and of simultaneously generating electric power (electricity), and a fuel cell to execute the method. The present invention is positioned as a core technique of a next-generation sustainable energy resource system: that decomposes and purifies biomass produced using the sunlight as its energy resource, and the waste thereof; and that simultaneously generates electric power (electricity). An object of the present invention is to establish a core energy system of the future that replaces the fossil fuels and the nuclear electric power generation, and to provide the system.

Assuming that the “discovery of fire” by the mankind in the Stone Age was the first energy revolution, the present invention corresponds to the second energy revolution, according to which electricity is directly and efficiently generated from biomass and oxygen without exploiting inefficient process such as combustion or heat that is, so to speak, in which method the electric charge is directly extracted from the biomass which had been produced using the sunlight as its energy resource.

### BACKGROUND ART

The environmental pollution due to the environmental pollutants such as biomass, organic/inorganic compounds, and the waste thereof has recently become increasingly serious. The degradation of the environment for the mankind to live in and the rapid reduction of the number of species of organisms are conspicuous. The global warming caused by the mass discharge of carbon dioxide into the atmosphere due to the combustion of the fossil fuels and the abnormal weathers attributed to the global warming frequently occur in various places throughout the world. Therefore, the environment for the mankind to live in is rapidly being degraded.

With these problems in the background, the nuclear electric power generation (nuclear generation) discharging no carbon dioxide started to markedly draw attention in and after 1990. However, the safety of the nuclear electric power generation was questioned because of the serious nuclear power station accident of Fukushima Daiichi Nuclear Power Station caused by the huge earthquake and the huge tsunami that occurred on Mar. 11, 2011 (the Great East Japan Earthquake), and the next-generation sustainable energy resource capable of replacing the nuclear electric power generation is actively discussed throughout the world. To immediately solve this serious and global-scale problem, decomposition and removal of the environmental pollutants such as biomass waste and creation of an innovative sustainable energy resource are strongly demanded. With this situation in the background, actually, several technologies are expected to solve the problems and research and development are being made, which technologies include; methods of decomposing and removing the environmental pollutants, wind power generation, solar power generation using photovoltaic cells, new renewable energy resources such as use of biomass, and electric power generation systems each using fuel cells.

However, in practice, the existing methods for decomposition and purification, and the existing energy resource production systems: are not fully established technically; each having low efficiency; requiring a high cost; and, thus, are not yet prevalent so widely.

The method has traditionally been executed, of completely decomposing and purifying dried biomass solid materials and biomass waste by simple combustion operations and, of simultaneously generating electric power. However, most of the biomass waste and factory effluents include a great quantity of water (85% or more) and, therefore, require supply of latent heat to evaporate the water when an attempt is made to simply combust these to generate electric power. Therefore, thou some amount of electric power may be generated by combustion, acquiring the net amount of energy cannot be actually realized.

A fuel cell has been proposed, and its research and development are being pursued as a candidate method of generating electric power from the biomass or organic materials that include especially much water, or the liquid as described above. However, the conventional fuel cell so far in practice was in operation under specified fuel conditions in which an extremely limited material such as hydrogen or methanol is to be used as the fuel. With conventional fuel cell using hydrogen etc., any direct electric power generation is difficult, when using other fuels such as various kinds of biomass, various kinds of biomass waste, organic/inorganic compounds, since the conventional fuel cell is unable to decompose such biomass.

Furthermore, researches have traditionally been conducted of biomass power generation using an enzyme, a microorganism, or carbon-supported platinum as a catalyst. However, their efficiency is extremely low and no technique thereof has ever reached the level for it to be put to practical use.

From such a viewpoint, the inventors have proposed a photo-physicochemical cell capable of fully photo-decomposing and purifying electron-donating compounds such as various kinds of biomass, organic/inorganic compounds, and their waste and effluents, and of simultaneously generating electric power (electricity), by using each of the electron-donating compounds as a direct fuel for the fuel cell.

According to the photo-physicochemical cell, the cell can be provided for use in the general society as a new electric power generation system replacing the solar cell and the fuel cell used so far. The basic patent thereof is as proposed in Patent Document 1 as “photo-physicochemical cell”. The inventors have disclosed “a bio-photochemical cell and a method of using the cell” in Patent Document 2, and “a bio-photochemical cell, a module, an analyzer, a teaching material, and a method of using these” in Patent Document 3. The inventors further have proposed the photo-physicochemical cell in Patent Document 4 as “a bio-photochemical cell highly efficiently photo-decomposing and purifying biomass, organic/inorganic compounds, or waste/effluents and simultaneously generating electric power” and “a method of photo-decomposing and purifying those compounds and the liquids and simultaneously generating electric power, using the bio-photochemical cell”.

### PRIOR ART DOCUMENTS

### Patent Documents

Patent Document 1: WO 2006-95916
Patent Document 2: Japanese Patent No. 4803554
Patent Document 3: Japanese Laid-Open Patent Publication No. 2006-119111
Patent Document 4: Japanese Patent Application No. 2009-43414

### Non-Patent Literature

Non-Patent Literature 1: Masao Kaneko and Junichi Nemoto, “Bio-Photochemical Cell”, Kogyo Chosakai Publishing Co., Ltd. (2008)

### SUMMARY OF THE INVENTION

### Problem that the Invention is to Solve

Though the efficiency of the photo-decomposition and purification is increased by virtue of the above proposals, the conversion efficiency into the electric power is not sufficient and a serious problem still remains before the use of the cell as a practical electric power generation system.

Originally, application of light is basically indispensable for these photo-physicochemical cells and, therefore, their electric power generation is available only in the daytime and the cells do not work at all in the nighttime. No electric power generation is also available on a rainy or cloudy day. Therefore, a fundamental problem has been present that the operating rate of the cells is significantly influenced by the whether or the climate condition.

Therefore, an object of the present invention is to provide an apparatus and a method to decompose and purify the fuel such as biomass and to generate electric power, through a fuel cell reaction without applying or irradiating any light thereto, that is, without applying any external energy thereto.

### Means to Solve the Problem

To solve the above problem, the inventors acquired the following idea. The biomass, organic/inorganic compounds, waste/effluents, the environmental pollutants, etc., each usable as fuel are electron-donating and, therefore, originally are compounds capable of reacting with oxygen without using any external energy such as light. Therefore, highly efficient decomposition and purification and, simultaneous highly efficient electric power generation ought to be enabled through a fuel cell reaction without using or supplying any other or external energy such as light by creating an unprecedented, innovative, and highly efficient catalyst, using the catalyst for an anode, and using the anode in combination with a counter cathode for oxygen reduction. From this viewpoint, the inventors explored a catalyst that can decompose highly efficiently the electron-donating compounds such as biomass, organic/inorganic compounds, waste/effluents, and the environmental pollutants without applying any light thereto, and reached the present invention.

According to the present invention, there is provided a method using the fuel cell reaction as below associated with decomposition and purification of the fuel.

[1]

A method for decomposing and purifying a fuel and generating electric power through a fuel cell reaction of the fuel without applying external energy, the method comprising:
(a) providing a composite anode composed of three layers including; a conductive electrode base layer/a porous semiconductor layer/a catalyst layer, the porous semiconductor layer being deposited on the conductive electrode base layer, the catalyst layer made of a metal, a metal oxide, or a semiconductor being formed on the semiconductor layer;
(b) immersing the composite anode in, or bringing the composite anode into contact with, a liquid phase comprised of an aqueous solution or an aqueous suspension that contains as the fuel at least one of or a mixture of biomass, biomass waste, and organic/inorganic compounds;
(c) disposing a counter cathode for oxygen reduction in the liquid phase comprised of the aqueous solution or the aqueous suspension or in an liquid phase/gas phase interface where the liquid phase is in contact with a gas phase; and
(d) supplying oxygen into, or causing oxygen to coexist in, the liquid phase where the cathode is disposed or the liquid phase/gas phase interface, thereby inducing the fuel cell reaction on the cathode, decomposing and purifying the fuel, generating electric power through the fuel cell reaction without applying external energy thereto.
   [2]

The method of [1], wherein atomic ratio of metal forming the catalyst layer to metal forming the semiconductor layer of the composite anode is 0.01/1 to 1,000/1.

According to the present invention, there is provided a fuel cell as below associated with decomposition and purification of the fuel.

[3]

A fuel cell comprising a composite anode and a counter cathode for oxygen reduction and decomposing and purifying a fuel and generating electric power through a fuel cell reaction without applying external energy thereto, wherein
(a) the composite anode is composed of three layers including; a conductive electrode base layer/a porous semiconductor layer/a catalyst layer, the porous semiconductor layer being deposited on the conductive electrode base layer, the catalyst layer made of a metal, a metal oxide, or a semiconductor being formed on the semiconductor layer, wherein
(b) the composite anode is immersed in, or in contact with, a liquid phase comprised of an aqueous solution or an aqueous suspension that contains as the fuel at least one of or a mixture of biomass, biomass waste, and organic/inorganic compounds, wherein
(c) the counter cathode for oxygen reduction is disposed in the liquid phase comprised of the aqueous solution or the aqueous suspension or in an liquid phase/gas phase interface where the liquid phase is in contact with a gas phase, and wherein
(d) the fuel cell is configured to supply oxygen into, or cause oxygen to coexist, in the liquid phase or the liquid phase/gas phase interface where the cathode is disposed, thereby inducing the fuel cell reaction on the cathode, decomposing and purifying the fuel and generating electric power through the fuel cell reaction without applying external energy thereto.
   [4]

The fuel cell for [3], wherein atomic ratio of metal forming the catalyst layer to metal forming the semiconductor layer of the composite anode is 0.01/1 to 1,000/1.

According to the present invention, there is provided a power generation method using a fuel cell as below associated with generation of pure metal.

[5]

A method for executing fuel-cell power generation without applying external energy thereto and simultaneously producing a pure metal using a cathode, the method comprising:
(a) providing a composite anode composed of three layers including; a conductive electrode base layer/a porous semiconductor layer/a catalyst layer, the porous semiconductor layer being deposited on the conductive electrode base layer, the catalyst layer made of a metal, a metal oxide, or a semiconductor being formed on the semiconductor layer;
(b) immersing the composite anode in, or bringing the composite anode into contact with, a liquid phase comprised of an aqueous solution or an aqueous suspension that contains as the fuel at least one of or a mixture of biomass, biomass waste, and organic/inorganic compounds;
(c) disposing a counter cathode for oxygen reduction in the liquid phase comprised of the aqueous solution or the aqueous suspension or in a liquid phase/gas phase interface where the liquid phase is in contact with a gas phase; and
(d) maintaining an ambience in the liquid phase where the composite anode is disposed, or the liquid phase/gas phase interface to be under an anaerobic condition, causing an oxide, a salt, and a complex of a metal produced by oxidizing a metal ore, a collected metal, or a scrap metal, to co-exist as an electron acceptor in the liquid phase or the liquid phase/gas phase interface, and thereby inducing the fuel cell reaction on the cathode, producing a pure metal and generating electric power without applying external energy thereto.
   [6]

The method of [5], wherein atomic ratio of metal forming the catalyst layer to metal forming the semiconductor layer of the composite anode is 0.01/1 to 1,000/1.

According to the present invention, there is provided a fuel cell as below associated with generation of pure metal.

[7]

A fuel cell comprising a composite anode and a counter cathode for oxygen reduction, executing or conducting fuel-cell power generation without applying external energy thereto, and simultaneously producing a pure metal at the cathode, wherein
(a) the composite anode is composed of three layers including; a conductive electrode base layer/a porous semiconductor layer/a catalyst layer, the porous semiconductor layer being deposited on the conductive electrode base layer, the catalyst layer made of a metal, a metal oxide, or a semiconductor being formed on the semiconductor layer, wherein
(b) the composite anode is immersed in, or in contact with, a liquid phase comprised of an aqueous solution or an aqueous suspension that contains as the fuel at least one of or a mixture of biomass, biomass waste, and organic/inorganic compounds, wherein
(c) the counter cathode for oxygen reduction is disposed in the liquid phase comprised of the aqueous solution or the aqueous suspension or in a liquid phase/gas phase interface where the liquid phase is in contact with a gas phase, and wherein
(d) an ambience in the liquid phase or the liquid phase/gas phase interface where the cathode is disposed is maintained to be under an anaerobic condition, and an oxide, a salt, or a complex of a metal produced by oxidizing a metal ore, a collected metal, or a scrap metal is caused to co-exist as an electron acceptor in the liquid phase or the liquid phase/gas phase interface, and thereby the fuel cell reaction is induced on the cathode, and producing the pure metal at the cathode and generating electric power without applying external energy thereto.
   [8]

The fuel cell of [7], wherein atomic ratio of metal forming the catalyst layer to metal forming the semiconductor layer of the composite anode is 0.01/1 to 1,000/1.

According to the present invention, there is provided a hydrogen production method using a micro fuel cell as below.

[9]

A method using a composite anode, of executing micro-fuel-cell electric power generation on the anode and simultaneously producing hydrogen on the anode, without applying external energy thereto, wherein
(a) the composite anode is composed of three layers including; a conductive electrode base layer/a porous semiconductor layer/and a catalyst layer, the porous semiconductor layer being deposited on the conductive electrode base layer, the catalyst layer made of a metal, a metal oxide, or a semiconductor, being formed on the semiconductor layer, wherein
(b) the composite anode is immersed in, or in contact with, a liquid phase comprised of an aqueous solution or an aqueous suspension that contains as the fuel at least one of or a mixture of biomass, biomass waste, and organic/inorganic compounds, and wherein
(c) an ambience in the liquid phase where the anode is disposed to be under an anaerobic condition, and the anode acts as a micro cell and, on the anode electrons being injected from the fuel in the liquid phase comprised of the aqueous solution or the aqueous suspension, and the injected electrons are being delivered to protons in the liquid phase comprised of the aqueous solution or the aqueous suspension, thereby producing hydrogen, and generating electric power without applying external energy thereto.
   [10]

The micro fuel cell power generation method of [9], wherein
atomic ratio of metal forming the catalyst layer to metal forming the semiconductor layer of the composite anode is 0.01/1 to 1,000/1.

According to the present invention, there is provided a micro fuel cell for producing hydrogen as below.

[11]

A micro fuel cell comprising a composite anode, executing micro-fuel-cell electric power generation on the anode without applying external energy thereto, and simultaneously producing hydrogen on the anode, wherein
(a) the composite anode is composed of three layers including; a conductive electrode base layer/a porous semiconductor layer/a catalyst layer, the porous semiconductor layer being deposited on the conductive electrode base layer, the catalyst layer made of a metal, a metal oxide, or a semiconductor being formed on the semiconductor layer, wherein
(b) the composite anode is immersed in, or in contact with, a liquid phase comprised of an aqueous solution or an aqueous suspension that contains as fuel at least one of or a mixture of biomass, biomass waste, and organic/inorganic compounds, and wherein
(c) an ambience in the liquid phase where the composite anode is disposed is maintained to be under an anaerobic condition, and the anode acts as a micro cell and, on the anode electrons being injected from the fuel in the liquid phase comprised of the aqueous solution or the aqueous suspension, and the injected electrons are being delivered to protons in the liquid phase comprised of the aqueous solution or the aqueous suspension, thereby producing hydrogen, and generating electric power simultaneously without applying external energy thereto.
   [12]

The micro fuel cell of [11], wherein atomic ratio of metal forming the catalyst layer to metal forming the semiconductor layer of the composite anode is 0.01/1 to 1,000/1.

### Advantageous Effect of the Invention

According to the traditional fuel cell technique, the extraction of electric power (electricity) by decomposing, through the fuel cell reaction, biomass, waste thereof, or other organic compounds or inorganic compounds, etc., as the direct fuel has been almost unrealized in practice except the case where the fuel is an extremely limited specific material such as hydrogen or methanol. In contrast, according to the present invention: the specific composite anode composed of; an anode electrode base layer/a porous semiconductor thin layer/a metal catalyst thin layer, is used together with the cathode electrode for oxygen reduction; and, thereby, generating electric power (electricity) is enabled by using, as the direct fuel the biomass, the waste thereof, or other organic compounds and inorganic compounds, etc., that are traditionally ignored and unemployed, and by highly efficiently decomposing and purifying these compounds through the fuel cell reaction without requiring the irradiation with any light.

Furthermore, production of hydrogen fuel is enabled by utilizing the composite anode alone as a micro fuel cell without using the cathode. According to the present invention, soft-path and energy-saving-type metal refining process requiring no other energy is enabled by using the composite anode of the present invention.

As above, according to the present invention, a biomass, a waste material thereof, or other organic/inorganic compounds that are traditionally unusable as the fuel of any fuel cell are used as the fuel, and electric power (electricity) can be generated by decomposing these compounds through the fuel cell reaction without applying any light thereto. Therefore, a basic sustainable energy resource system can be constructed.

### BRIEF DESCRIPTION OF DRAWINGS

FIG. 1 is a conceptual diagram of: an [electrode base layer/n-type semiconductor layer/metal catalyst thin layer] composite as a highly active anode catalyst electrode; a cell configuration comprised of a Schottky junction (barrier) formation in the semiconductor and a counter cathode; and a decomposition and electric power generation mechanism for biomass, etc.

FIG. 2 is a graph of an I-V property showing a result of an example.

FIG. 3 is a graph of a Pt/Ti atom ratio dependence property of a maximum power output showing a result of an example.

### EXPLANATIONS OF REFERENCE LETTERS AND NUMERALS

2 composite anode of the present invention
5 fuel cell
10 metal catalyst layer
12 biomass (electron donor)
14 electron
20 porous semiconductor layer
30 conductive electrode base layer
40 cathode for oxygen reduction
42 external circuit (external conductive wire)
B Schottky barrier
m potential gradient
CB conduction band
VB valance band
i electric current

### MODES FOR CARRYING OUT THE INVENTION

The present invention will be described in detail.

The material design policy and the catalyst conditions constituting the basis of the present invention are configured by the following idea.

(1) The catalyst must have a general oxidation catalytic activity for a wide variety of electron-donating compounds used as the fuel (=an electron donor), such as various organic/inorganic compounds, waste materials/effluents, and environmental pollutants.
(2) As to a interaction of catalyst (C) and a substrate (S, the fuel in this case), the substrate approaches the catalyst to first form an activated complex (C−S, a kind of intermediate). Thereafter, electrons move from the fuel to the catalyst and the activated complex is separated into C⁻ and S⁺ (the oxide of the fuel) as expressed by Eq. (1).

C+S⇄C−S⇄C⁻S⁺→C+counter electrode(electron)+S⁺ (1)

In Eq. (1), the electron which moved to the catalyst, moves to the counter electrode, where it is delivered to oxygen, and reduces the oxygen, and water is produced. The oxide (S⁺) of the fuel reacts with the catalyst one after another and is oxidized. Finally, carbon becomes carbon dioxide (CO₂) and nitrogen becomes nitrogen molecules (N₂), thus to participate in the circulation process in the nature.

The reaction for the activated complex C−S to be produced from C and S and the reaction for the C−S to be decomposed or separated into C⁻ and S⁺ are equilibrium reactions. Thus, the reverse reaction for C−S to return to the original C and S always takes place in parallel. Therefore, C−S is not necessarily decomposed easily into C⁻ and S⁺ and, in many cases, by reverse reaction, C−S returns to its original form, C and S. To facilitate the decomposition of C−S, it is important to take appropriate measures to move the electron from the decomposed C⁻ as quickly as possible to another place to prevent the electron from returning to its original position.

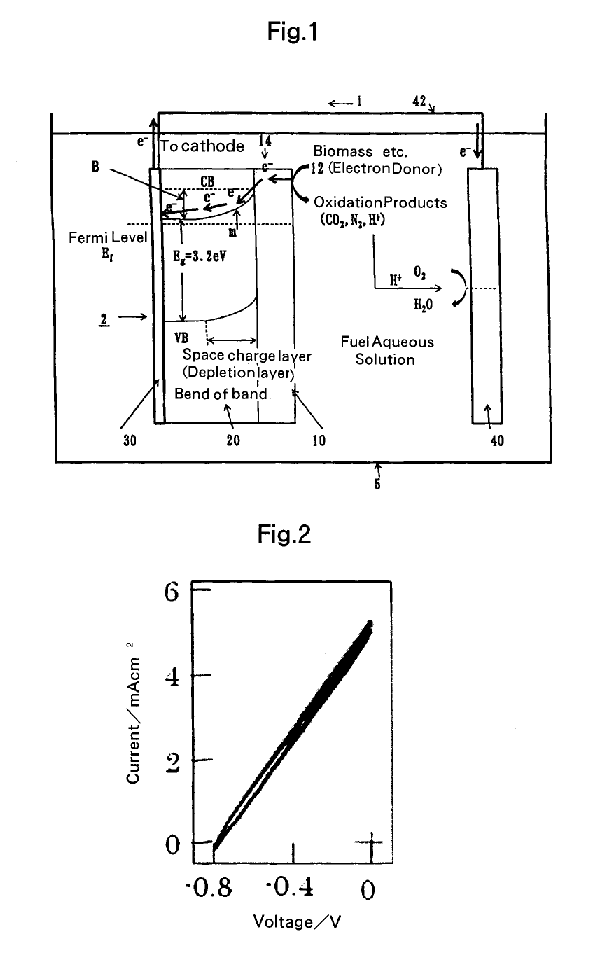

For this purpose, exploitation is contemplated of a Schottky barrier (a bend of the band structure) formed between a catalyst layer and an n-type semiconductor, by bringing the semiconductor into contact with the catalyst layer. As depicted in FIG. 1 later, the band structure of the semiconductor (a valence band VB and a conduction band CB) is bent at an interface between the n-type semiconductor, and a solution or a metal and, in this portion (referred to as “space-charge layer” or “depleted layer”), an electron (e⁻) moves along the gradient toward a lower position at which energy is lower (in FIG. 1, the leftward direction).

When, for example, the catalyst C is present on the surface of the semiconductor, the electron injected from the electron donor (S) (fuel) such as a biomass in the liquid phase, that is the fuel in contact with the catalyst C, moves toward the inside of the semiconductor along the bend of the band. Therefore, C⁻ quickly returns to C and, thus, the reaction of Eq. (1) quickly advances rightward. It is thus expected that the catalytic reaction of Eq. (1) is facilitated by using the n-type semiconductor depicted in FIG. 1 (described later in detail). The electron: moves into the semiconductor layer; arrives in a conductive portion (a conductive electrode base 30) of the anode electrode; thereafter, goes to a counter cathode 40 through an external conductive wire (an external circuit) 42; reduces oxygen there; and produces water. Thereby, the electric power (electricity) generation through the fuel cell reaction is completed. A current flowing in the external circuit flows in the direction from the cathode toward the anode.

However, this alone is not sufficient to realize the anode/catalyst. To increase the efficiency, it is important to increase as much as possible the area of the contact interface between the catalyst and the fuel liquid layer, and the area of the contact interface between the catalyst and the semiconductor. For this purpose, the area of the catalyst/semiconductor interface can be set to be significantly large, by exploiting a highly porous layer structure for the semiconductor, instead of a simply flat layer. For example, a porous n-type semiconductor thin layer is formed on an electrode to be the anode base, and a catalyst thin layer is formed on the surface of this porous semiconductor. Thereby, the purpose of the present invention can be achieved.

The present invention basically provides a method of generating electric power (electricity) using a fuel cell [1] and the fuel cell [2] as below.

The present invention provides a method for decomposing and purifying the fuel and simultaneously generating electric power through a fuel cell reaction of the fuel without applying any external energy thereto, that is,

[1] a method for decomposing and purifying a fuel and generating electric power through a fuel cell reaction without applying any external energy thereto, and the method comprising:
(a) providing a composite anode 2 composed of three layers including; an electrode base layer/a porous semiconductor layer/a catalyst layer, manufactured by depositing the porous semiconductor thin layer 20 on or over the conductive electrode base layer 30 and forming the catalyst layer 10 made of a metal, a metal oxide, or a semiconductor on top or over the semiconductor layer;
(b) immersing the composite anode in, or bringing the composite anode into contact with, a liquid phase comprised of an aqueous solution or an aqueous suspension that contains as the fuel at least one of, or a mixture of, biomass, a biomass waste, and organic/inorganic compounds;
(c) disposing or installing a counter cathode for oxygen reduction in the liquid phase comprised of the aqueous solution or the aqueous suspension or in an liquid phase/gas phase interface, where the liquid phase is in contact with a gas phase; and
(d) supplying oxygen into, or causing oxygen to coexist in, the liquid phase or the liquid phase/gas phase interface where the cathode is disposed, thereby inducing the fuel cell reaction on the cathode, and decomposing and purifying the fuel and generating electric power.

The present invention also provides

[2] a fuel cell including the composite anode 2, and the counter cathode 40 for reducing oxygen, for executing decomposition and purification of the fuel and generation of electric power through the fuel cell reaction without applying any external power thereto, wherein
(a) the composite anode 2 is a composite anode composed of three layers including; an electrode base layer/a porous semiconductor layer/a catalyst layer, manufactured by depositing the porous semiconductor layer 20 on the conductive electrode base layer 30 and forming the catalyst layer 10 made of a metal, a metal oxide, or a semiconductor on the semiconductor layer, wherein
(b) the composite anode is immersed in, or in contact with, the liquid phase comprised of the aqueous solution or the aqueous suspension, that contains as the fuel, at least one of or a mixture of the biomass, the biomass waste, and the organic/inorganic compounds;
(c) the counter cathode for oxygen reduction is disposed in the liquid phase comprised of the aqueous solution or the aqueous suspension or in the liquid phase/gas phase interface, where the liquid phase is in contact with the gas phase, and wherein
(d) oxygen is supplied into, or caused to coexist in, the liquid phase or the liquid phase/gas phase interface, where the cathode is disposed, thereby inducing the fuel cell reaction on the cathode. (See FIG. 1 for the reference numerals.)

### (Composite Anode (Electrode Base Layer/Semiconductor Layer/Catalyst Layer))

In the present invention, the specific composite anode defined and prepared in the invention is used. The composite anode is basically composed of a three-layered composite including; the conductive electrode layer as a base/the semiconductor layer/and the catalyst layer. For example, the composite anode is composed of three layers comprising the electrode base layer, the porous semiconductor layer, and the catalyst layer, that are manufactured by depositing the porous semiconductor layer on or over the conductive electrode base layer and forming the layer of a catalyst made of a metal, a metal oxide, or a semiconductor on the semiconductor layer.

The conductive electrode base can be, for example, an electrode of conductive glass such as ITO or FTO, or an electrode made of: a metal such as titanium, copper, iron, aluminum, silver, gold, or platinum; or an organic or a polymeric conductive material such as carbon or felt.

An n-type semiconductor is mainly used as the semiconductor to form the semiconductor layer. The n-type semiconductor is not especially limited and can be, for example, titanium dioxide, zinc oxide, tin oxide, tungsten oxide, cadmium sulfide, an organic semiconductor, or a polymeric semiconductor. Preferably, in the composite, the semiconductor layer is made of a porous layer (a porous semiconductor layer) whose semiconductor is a nano-structured porous material as described above, to increase the interfacial area between the semiconductor layer and the catalyst layer (semiconductor layer/catalyst layer). The “nano-structure” refers to a structure whose fine pores diameter (pore size) is 0.1 nm to several thousand nm, preferably is two nm to several hundred nm, and, more preferably is about 10 nm to about 50 nm and whose specific surface area is about 1 to 10,000 m²/g. (The effective surface area of the porous layer reaches two to several thousand times as large as and, normally, about several hundred to about 2,000 times as large as the apparent surface area.)

As the catalyst to form the catalyst layer, such a known oxidation catalyst and a reduction catalyst are used. The exemplary catalyst materials include, but not especially limited to, a metal catalyst such as: platinum, gold, iridium, osmium, manganese, iron, cobalt, nickel, copper, zinc, molybdenum, ruthenium, rhodium, palladium, silver, cadmium, or indium. In addition, an oxide of each of these metals, or a semiconductor, an inorganic complex, an organic catalyst, and a polymeric catalyst, etc., are also used as the catalyst.

A catalyst generally often has a reaction specificity for a substrate to be decomposed (that is, the fuel such as a biomass or its associated compound). However, as described later, the composite anode of the present invention enables decomposition of various substrates and thus contributes to electric power generation therewith. When mixed biomass including different compositions is processed as necessary, a catalyst such as a metal effective for each kind of biomass is available and, therefore, such a metal is selected for each biomass. In this manner, a composite anode is employed that uses the mixed catalyst composed of the most preferred plural different metals and, furthermore, several kinds of such anode with mixed catalysts are used in combination. Thereby, biomass having a complicated composition can also simultaneously be decomposed and used to generate electric power.

A biomass compound is multi-electron reactive and, for example, a typical glucose is a 24-electron donor per one molecule. To increase its decomposition efficiency, a multi-electron decomposition catalyst is required. However, such a catalyst is traditionally not present and unavailable. The catalyst such as a metal of the composite anode of the present invention has an extremely high activity by virtue of the contribution thereto by the double nature (double properties) of the bend of the band structure based on the Schottky junction produced in the semiconductor and the ohmic junction between the semiconductor and the catalyst (a smooth move of the electron from the catalyst to the semiconductor based on the Ohm's law) and, therefore, is a catalyst for multi-electron decomposition and electric power generation, that can use at 100% the electrons capable of being donated by the biomass. While this kind of ohmic junction is usually not created between an ordinary semiconductor and an ordinary catalyst, in the present invention, the semiconductor having the nano-structured porous body, which enables a smooth movement or transport of the electrons from the catalyst to the semiconductor, based on the Ohm's law.

### (Manufacture of Porous Semiconductor Layer)

In the present invention, the method of manufacturing the semiconductor porous layer on or over the conductive electrode base layer is not limited and, for example, a method described as below is employed that uses semiconductor fine particles as its starting material (such as coating or sintering). Semiconductor particles are first prepared that have an average particle diameter of 1 nm to 1 mm, preferably 10 nm to 1,000 nm, and more preferably about 10 nm to about 500 nm (for example, in case of fine particles of titanium dioxide, those of an anatase type, a rutile type, a brookite type, or a mixture type including two or three of these types). These semiconductor particles are added with a surface-active agent to facilitate dispersion and with small amounts of an organic medium, water, etc. These materials are mixed and sufficiently kneaded in a mortar, ball mill, etc. to produce a semiconductor paste. (A commercially available paste can also be selected and used as the semiconductor paste and, for example, a TiO₂ nano-particle paste is also usable.)

Thus produced or selected commercially available semiconductor paste is applied using a screen printing method, a squeezing method, a doctor blade method, a spin coating method, an application method, etc., on to a conductive electrode base, for example, a conductive electrode base comprised of a conductive glass (referred to as “FTO”) deposited with a conductive tin oxide thin layer doped with, for example, fluorine to impart heat resistance.

Any arbitrary base is usable as the conductive electrode base in addition to FTO, these bases including: a conductive metal such as copper, titanium, iron, cobalt, nickel, zinc, platinum, gold, or silver, an organic conductive material, and a polymeric conductive material, etc. These materials which are usable as the base are not limited to these materials as mentioned above.

This paste-applied or coated film (layer) is first heated and dried at, for example, 100° C. for about 30 min, and the process of paste application and drying is repeated for several times as necessary to acquire a desired thickness. Finally, the paste-applied film (layer) is sintered at, for example, 450° C. for about 30 min to acquire an anode (an anode base substrate) having the porous semiconductor thin layer deposited on the conductive electrode base substrate. (In the next process step, the catalyst layer is formed by being deposited on, or over this anode base substrate, and, thereby, the composite anode is formed.) Adjustment of the viscosity of the paste enables the acquisition of the thin layer having the desired thickness even in one application step. Thus, adopting appropriate adjustment of paste viscosity can simplify the coating procedure considerably.

As the thickness of the porous semiconductor layer, a thickness of about 10 nm to about 1 mm is basically employed. However, the thickness is, preferably, about 5 μm to about 100 μm and is, more preferably, about 5 μm to about 50 μm. As to the layer thickness, a larger thickness basically provides a higher activity and, for example, a layer thickness of 20 μm provides a much higher activity and is more preferred than that of 10 μm. However, on the other hand, when the layer thickness becomes too large, the property such as the adhesiveness of the layer for the electrode base is degraded. Therefore, preferably, a suitable layer thickness is selected within the above range. As one example, when a thin layer whose layer thickness is 20 μm is manufactured using a paste of titanium dioxide fine particles (whose average particle diameter is 13 nm) and using the application method and the sintering method as above. The effective surface area of this porous thin layer reaches 2,000 times as large as its apparent surface area and, therefore, its activity is extremely high.

### (Formation of Catalyst Layer by Deposition on Anode Base Substrate)

In the present invention, the composite anode is manufactured by forming a layer of a catalyst layer on or over the anode base substrate formed by depositing the porous semiconductor thin layer on the electrode base substrate. The thickness of the catalyst layer is 0.1 nm to 1 mm, preferably, 0.2 nm to 100 μm, and, more preferably, about 0.4 nm to about 30 μm.

For the manufacture of this catalyst layer, any of various known methods is employed such as depositing a metal or its oxide from a corresponding metallic salt on the porous semiconductor layer using a photo-reduction method (a photo-deposition method), or a method such as that of depositing a metal or its oxide using an electrochemical reduction method (an electrochemical deposition method), or a chemical plating method.

FTO basically provides an excellent activity as described above as the anode base electrode. However, an FTO base electrode has lower conductivity than that of a metal and, therefore, problems arise that the FTO base electrode is not suitable for any scale-up procedure in size of this method and that the cost thereof being very high. As opposed to this, when a highly conductive metal base electrode such as that made of Ti or Cu, or a highly conductive base electrode such as that made of graphite or a carbon-based material is used, the conductivity is not reduced so significantly even with its increased anode area and, therefore, its property is not degraded with increase in time. Therefore, this base electrode provides an excellent result.

### (Photo-Deposition Method)

The photo-deposition method will first be described. Taking an example, for example, where a Pt layer is formed on a TiO₂ porous semiconductor thin layer that is an n-type semiconductor, the photo-deposition method will be described with reference to FIG. 1.

To employ a platinum metal as the catalyst, for example: a predetermined amount of potassium chloroplatinate, 2K⁺[Pt(IV)Cl₆]²⁻, into water including methanol of 3% (vol/vol) as a reducing agent such that the Pt/Ti atomic ratio (φ) of the composite anode to be produced at a target value; the anode base substrate having the TiO₂ porous semiconductor layer deposited thereon is immersed in the mixed aqueous solution including methanol and chloro-platinic acid; and white light is irradiated or applied to the anode base substrate from the side of the semiconductor thin layer or the conductive electrode. (As described later, preferably, the Pt/Ti atomic ratio 431 is set to be about 0.01/1 to about 1,000/1.)

With an ultraviolet-region semiconductor whose semiconductor band gap (Eg) is larger than 3 eV, the semiconductor absorbs the ultraviolet light in the white light and while, with a visible-range semiconductor whose Eg is smaller than 3 eV, the semiconductor absorbs the visible light therein and, thereby, an electron (e⁻) is excited from the valence band (VB) to the conduction band (CB) in the semiconductor and a hole (h⁺) lacking the electron remains in VB. Immediately after this excitation, the electron and the hole are present in a state called an exciton state (a couple of an excited electron and a hole) where the electron and the hole have short lives and quickly recombination of them occurs.

During the process of the photo-deposition method: a space-charge layer (otherwise, referred to as “depletion layer”) whose thickness is about several nm to about several hundred nm is present in the interface between the semiconductor and the solution (a semiconductor/solution interface); a what-is-called Schottky (schottky) junction (barrier) B is formed; and the band structure is bent (called “Band bending”) with a potential gradient m. In an n-type semiconductor, this gradient (slope) extends in the direction from the interface toward the inside, toward a larger positive potential (downward in FIG. 1). (However, for a p-type semiconductor, the gradient extends in the opposite direction.)

The exciton itself is unstable and has a short life and, therefore, quickly recombination occurs when the exciton is left as it is. However, due to the potential gradient (bending) in the space-charge layer of this Schottky junction, in the n-type semiconductor, the hole of the exciton moves toward the semiconductor/liquid interface and the electron moves toward the inside of the semiconductor. Thus, the positive and the negative charges are separated from each other. The hole appears on the surface of the semiconductor and, receives another electron from a methanol electron-donor in the liquid. The electron thus remains in the semiconductor. When such electrons accumulate, the electrons move into the semiconductor/aqueous solution interface and reduce the platinum salt. The platinum is reduced to a zero-valence metal and is simultaneously deposited on the surface of the semiconductor. In this manner, platinum, the catalyst, is deposited on the porous semiconductor thin layer from potassium chloroplatinate, a metallic salt corresponding to platinum, using the photo-reduction method. In this manner, the composite anode (the electrode base layer/the semiconductor layer/the platinum catalyst layer) 2 is formed.

### (Electrochemical Deposition Method)

The electrochemical deposition method will be described. When the electrochemical deposition method is employed: the anode base substrate having the porous semiconductor thin layer deposited thereon is immersed in an aqueous solution of a target metallic salt; an electrolyte is dissolved therein as necessary; a sufficient reductive potential is applied thereto; and the metal is reduced to a zero-valence metal using a constant current process or a constant voltage process and is caused to simultaneously deposit on the semiconductor thin layer. Thereby, the metal thin layer can be formed to constitute the catalyst. In this manner, the composite anode (the electrode base layer/the semiconductor layer/the catalyst layer) 2 is formed.

### (Formation of Schottky Junction (Barrier) and Ohmic Junction in Porous Semiconductor)

As can be understood from the above deposition mechanism, the metal catalyst such as Pt is deposited from the surface of the porous semiconductor, that is, deposited on the inner surface of the nano-pores of the nano-structured porous material. Therefore, the Schottky junction (a barrier) B is formed in vicinity of the metal interface of the semiconductor (see FIG. 1). A composite comprised of; the porous semiconductor/the metal, is formed and, therefore, the (the porous semiconductor/the metal) composite forms, so called, a nano-order complicated interface structure, and the Schottky barrier B (the bend of the band structure) is formed in the vicinity of the semiconductor interface. In addition, because the semiconductor forms the fine nano-structure, the junction between the semiconductor and the catalyst also has an ohmic property (meaning that a charge is transferred according to the Ohm's law), which allows the electron to move smoothly from the catalyst to the semiconductor. It is considered that, due to this mechanism, the electron after moving from the substrate (the fuel to be decomposed) to the catalyst quickly moves to the semiconductor layer, and the electron after this move tends to continuously move inward of the semiconductor due to the bend of the band structure and, which mechanism functions to facilitate the shifting of equilibrium system expressed in Eq. (1) toward a production system side.

The Schottky junction is formed between a semiconductor and a metal and an organic conductive material, etc., and, therefore, preferably, the metal, etc., to cover the semiconductor is not partially deposited in the form of blocks on the semiconductor but covers the overall (all surface area of) semiconductor as a thin layer of the metal, etc. At the same time, preferably, the metal is in the form of a crystal. A metallic crystal is characterized in that the metal includes free electrons and, therefore, the metallic crystal usually has an appearance of metallic luster originating from the free electrons. Actually, the inventors of the present invention confirm that, when the invention is implemented, the highly active anode often has metallic luster on its surface.

Conventionally, of the photo-fuel cells including that already proposed by the inventors, adopted a photo-anode formed by depositing a small amount of platinum catalyst on a semiconductor. However, when platinum-catalyst (photo-anode) is used as a photo-fuel cell, obstruction may occur by the deposited platinum layer of transmission of the light to be applied to the photo-anode and, thus, sufficient or significant amounts of platinum cannot be deposited. In this case, the platinum is present as a platinum black aggregate and the color of its appearance is also black.

Meanwhile, however, the fuel (battery) cell of the present invention has an important and significant characteristic in that application or irradiation of any light is fundamentally unnecessary to cause the fuel cell to operate. As described in the examples described later, the fuel cell of the present invention has the important characteristic in that application or irradiation of any light is completely unnecessary and any consideration concerning the transmission of light is fundamentally unnecessary, which enabled deposition of a large, and up to desired, amount of platinum. Under the above condition where sufficiently a large amount of platinum is deposited as a layer and the platinum presents its metallic luster appearance, the catalyst activity is high and, thus, this platinum metallic crystal (that may be an aggregate of fine crystals) shows higher conductivity than that of the platinum black aggregate. Therefore, it is considered that the quick move to the semiconductor layer of the electrons injected into the platinum catalyst layer also significantly contributes to the high catalyst activity.

### (Disposition of Composite Anode in Liquid Phase or Liquid Phase/Gas Phase Interface)

In the present invention, the composite anode manufactured and prepared as described above is immersed in, or in contact with, a liquid phase comprised of an aqueous solution or an aqueous suspension that contains as the fuel at least one of or a mixture of biomass, biomass waste, and organic/inorganic compounds.

Normally, the composite anode has a plate-like shape and is immersed in a cell container (a tank-type container) accommodating the liquid phase containing the biomass. However, in some case, the wall surface (or its portion) of the cell can be configured by the composite anode itself. In this case, the composite anode is in contact with the liquid phase containing the biomass. Even in this mode of anode-disposition, its embodiment or implementation is possible.

### (Conditions of Liquid Phase Comprised of Biomass Solution or Biomass-Containing Suspension)

As to the liquid phase for implementing the present invention, the reaction can basically be carried out in any of an acidic, a basic, and a neutral liquid phase. However, to effectively advance the reaction, a more preferred pH is present. For example, the reaction rate can vary depending on the kind of biomass and the kind of composite anode and, therefore, preferably, a preferred pH is selected according to these factors. A more preferable value for each of specific kinds of biomass and each of specific kinds of composite anode (φ (=M/S), M, S) is as listed in the examples described later. For example, preferably, the liquid phase ought to be substantially strongly basic (pH=14) when glucose is used as the biomass fuel.

### (Counter Cathode for Oxygen Reduction and its Disposition in Liquid Phase or Liquid Phase/Gas Phase Interface)

In the present invention, a cathode used as a counter electrode (counter cathode) is caused to have an oxygen reducing catalyst function. Typically, when the cathode is used in a liquid phase such as water, for example, the cathode is used in which an oxygen reducing catalyst such as platinum is dispersed or deposited on the conductive electrode. The counter cathode may be disposed in the liquid phase such as an aqueous solution. However, the efficiency is increased or enhanced when oxygen in a gas phase is used. The reason for this is that the solubility of oxygen in water is low and the partial pressure of oxygen is about ⅕ in the atmosphere and, therefore, the concentration of oxygen in water under atmosphere (the dissolved oxygen level) is equal to, or lower than 0.2 mM, that is very low.

Therefore, more preferably, when the counter cathode is so structured as to be able to make use of oxygen, not the dissolved form in the liquid phase, but oxygen in the gas phase such as the air, the decomposition and the electric power (electricity) generation properties of the fuel cell are further enhanced. The oxygen concentration in terms of the concentration per unit volume is about 0.2 mmol/L in water while 45 mmol/L in the air phase, the concentration in air being 225 times as high as that in water. The diffusion coefficient of oxygen (that is, a coefficient (an index) of the transfer rate of an oxygen molecule to the surface of the counter cathode) in a gas phase is higher than that in a liquid phase by at least about five digits and, therefore, utilization or application of oxygen in the gas phase is advantageous.

When oxygen in the gas phase is applied, one surface (side) of the counter cathode is in contact with the liquid phase and the other surface (side) thereof is in contact with the gas phase as the cell configuration. The cathode structure to achieve this purpose needs a contraption or strategy. For example, a membrane electrode assembly (MEA) having a two-layered structure of; an electrolyte membrane such as Nafion membrane/a platinum-supported carbon catalyst dispersed carbon paper sheet, etc., is more preferable because of this assembly's excellent cathode property for utilizing oxygen in the gas phase. “Nafion” (a registered trademark of E. I. du Pont de Nemours and Company) is a perfluorocarbon electrolyte membrane having therein a polytetrafluoroethylene (PTFE) skeleton and sulfonate groups. The electrolyte membrane is preferred because the electrolyte membrane, as a cation exchanger, transmits the proton (H⁺) sufficiently well necessary for reducing oxygen and producing water. Similarly, usable electrolyte membranes are Aciplex (a registered trademark of Asahi Kasei Corp.) and Flemion (a registered trademark of Asahi Glass Co., Ltd.) and are not limited to these.

In the present invention, when the area of the cathode (counter electrode) is too small, the oxygen reducing reaction to be caused on the cathode functions as a rate-determining step for the overall cell and, therefore, preferably, the cathode area is made sufficiently large. Actually, the inventors found that, when the cathode area was increased, more amount of electric power is generated exceeding (than) the amount corresponding to the increased cathode area (see Example 9). As described above, in the present invention, in the same way as with the anode, the dimensions and the property of the counter cathode are the important factors controlling the electric power generation rate (property).

### (Generated Theoretical Voltage and Voltage Increase Effect)

Though the generated theoretical voltage (the open-circuited electromotive force Voc) of the fuel cell of the present invention is 1.2 V to 1.3 V, it turned out as the confirmation made by the inventors that the voltage of the cell was able to actually reached a voltage equal to or higher than 1.6 V and, thereby, significantly increasing the electric power generation. It is presumed as the reason for this that: for the cathode, a separating membrane such as Nafion film is used that is a proton conductor (a proton exchanger) between the liquid and the catalyst such as platinum; this separating membrane takes the protons into its inside and locally condenses the protons; thereby, in the separating membrane, the proton local concentration becomes extremely higher than that in the liquid (that is, pH is lowered); therefore, the potential of the cathode shifts toward a positive potential; and, thereby, Voc is significantly increased.

### (Method of Decomposing and Purifying Biomass and Organic or Inorganic Compounds and Simultaneously Generating Electric Power)

The composite anode manufactured as described above has a function of decomposing and purifying highly efficiently a fuel such as various kinds of biomass and organic or inorganic compounds (hereinafter, collectively referred to as “substrate”) and of simultaneously generating electric power (electricity) corresponding to a combination of the porous semiconductor and the catalyst, as the composite anode being composed of the three layered structure including; the electrode base layer/the porous semiconductor layer/the catalyst layer, manufactured by depositing the porous semiconductor layer on the conductive electrode base layer, and forming the catalyst layer made of a metal, a metal oxide, or a semiconductor on or over the semiconductor layer.

As depicted in FIG. 1 schematically depicting the principle of the present invention, in which the fuel cell is configured by immersing the composite anode 2 composed of the three layers including; the electrode base layer/the porous semiconductor layer/the catalyst layer, and the counter cathode 40 having the oxygen reducing catalyst function, in the liquid phase comprised of an aqueous solution or an aqueous suspension that contains the substrate such as biomass and the thus configured cell can decompose and purify the substrate and simultaneously generate electric power without supplying external energy such as application or irradiation of light to the cell.

In the system configuring the fuel cell of the present invention, the electrons are extracted from the substrate (the fuel) at the anode, and are transferred to the cathode, and are delivered to oxygen and, thereby, the electric power (electricity) is generated. Thus, this cell corresponds to a fuel cell using the substrate such as biomass as a direct fuel (referred to as “biomass direct fuel cell” or simply “direct fuel cell”).

### (Reaction Mechanism of Fuel Cell)

As an example, FIG. 1 depicts the mechanism for the decomposition and the purification of the substrate and the simultaneous electric power generation using the composite anode 2 comprised of; the electrode base layer/the porous semiconductor layer/the catalyst layer, that utilizes the fuel cell reaction. “5” denotes the fuel cell. The catalyst layer 10 such as platinum takes the electron from the substrate 12 such as biomass and decomposes the substrate in oxidizing manner. The exploited or extracted electron 14 then moves into the inside of the semiconductor due to the space-charge layer (the bend m of the band) in the adjacent porous semiconductor layer 20, which makes it difficult for electron to return to the substrate 12, its original location. Thus, the equilibrium of Eq. (1) is made to shift toward the production system side.

In this manner, the electron 14 after moving into the inside of the porous semiconductor layer 20, moves to a conductive portion of the anode electrode base 30, goes to the counter cathode 40 through the external circuit 42 (at this time, a current i flows in the direction from the counter cathode 40 to the composite anode 2), and reduces oxygen there to produce water.

According to the biomass direct fuel cell of the present invention, the biomass and its related compounds can be completely decomposed and their final decomposition products are carbon dioxide (CO₂) water (H₂O), and N which becomes nitrogen (N₂). These complete decomposition reaction is referred to as “mineralization”. These decomposition products are also the raw materials for the photosynthesis and, therefore, carbon dioxide, nitrogen, and water on the earth eventually circulate through the photosynthesis and the fuel cell reaction of the present invention. The carbon dioxide produced by combusting fossil fuels increases the amount of carbon dioxide in the earth's atmosphere and, therefore, is regarded as the main cause of the global warming and the abnormal climate. However, biomass is formed by fixing carbon dioxide originally present in the global atmosphere utilizing the photosynthesis and, therefore, the atmospheric carbon dioxide concentration does not eventually vary substantially. Thus, the global warming problem can be avoided.

To demonstrate the significance of the present invention, approximate figures will be presented for the current global energy state. The globally accumulated potential amount of biomass is about 100 times as much as the global annual primary energy demand and, therefore, the energy demand is fully satisfied by annually using only 1% of the biomass. From another viewpoint, the accumulated biomass amount is about 10 times as much as the annual photosynthesis biomass production amount and, therefore, the energy demand is satisfied by using about 10% of the annual photosynthesis biomass production amount. The biomass wastes such as domestic animal wastes, agricultural wastes, kitchen garbage, and thinnings to maintain and control forests are the main cause of the environmental pollution. Thus, the energy held by these biomass wastes is in fact as much as ⅓ of the global energy demand and, therefore, the biomass wastes will be precious energy resource in the future in addition to the ordinary biomass. Taking into consideration the above described facts, the significance of the present invention is obvious.

As described later in an example 2, in the present invention, it was found that there exists an extremely singular and optimal condition for the atomic ratio φ (=M/S) of the metal M constituting the catalyst to the constituting element S of the semiconductor in the composite anode 2. This atomic ratio optimal condition φ differs for a different kind of semiconductor and a different kind of metal and, even for the combination of the same kind of semiconductor and the same kind of metal, also differs depending on: the semiconductor particle diameter; the degree of porosity of the semiconductor layer; the semiconductor layer thickness; the light intensity used when the photo-deposition method is employed; the conditions for the constant potential to be applied and the constant current used when the electrochemical-deposition method is used; etc. Therefore, the optimal ratio is present for each of the conditions. As for φ, the optimal ratio differs depending on the kind of substrate to be decomposed. The atomic ratio φ (=M/S) generally provides an excellent fuel cell property when φ is 0.01/1 to 1,000/1 and is, preferably, about 0.1/1 to about 200/1. To vary the atomic ratio φ (=M/S), this can easily be varied by varying, for example, the ratio of the layer thickness of the porous semiconductor layer to the layer thickness of the catalyst layer (in contrast, the atomic ratio φ may be regarded as approximately representing the ratios of the layer thicknesses of the composite anode).

For φ, difference was also found to exist as to which of the metal layers deposited employing the photo-deposition method and the electrochemical deposition method provided a preferred result. For example, when electric power is generated by decomposing glucose by the composite anode including the configuration of a TiO₂ semiconductor and a platinum metal, the photo-deposition method provides a more excellent result. Especially, the Pt/Ti atomic ratio φ in this case provides an excellent fuel cell property, that is typically 0.01/1 to 1,000/1 and is preferably about 0.1/1 to about 200/1.

### (Realization of Biomass Direct Fuel Cell Based on Multi-Electron Reaction Process of Present Invention)

An enzyme fuel cell, a microorganism fuel cell, or a glucose fuel cell using platinum as its catalyst is traditionally known as the bio-fuel cell using a specific compound in biomass as its fuel. However, for the enzyme fuel cell, the microorganism fuel cell, or the ordinary platinum catalyst, the kinds of substrate decomposable thereby are limited and, in addition, only decomposition corresponding to the first two electrons occurs. Taking an example of a glucose substrate, 24 electrons can be donated, in principle. However, a serious problem with it is that the decomposition and the electric power generation can be executed for the amount involving and corresponding to only two of those electrons.

In contrast, according to the present invention, the catalyst at the composite anode has an extremely high activity due to the contribution by the bend of the band structure and the ohmic junction (injection of electrons from the biomass to the anode based on the Ohm's law) formed in the semiconductor, which enables the catalyst to perform multi-electron decomposition and electric power generation, thus utilizing substantially 100% of the biomass electrons which are capable of being donated. In this regard, the catalyst basically differs from those in the traditional fuel cells. This indicates that the direct fuel cell of the present invention fundamentally differs in the operation principle of mechanism from those of the traditional fuel cells.

According to the method of the present invention, the decomposition activity and the electric power generation activity for biomass are very high and, therefore, the biomass can be used in the decomposition and the electric power generation, as it is or after only finely pulverizing or crushing its cells and other aggregation structures mechanically or physically using a homogenizer, etc. In case for handling specimens which are difficult to decompose and whose decomposition rate is very low, first bring them to be immersed in an acid or alkali water, decompose them to some degree in advance, and then the specimens can be used in the decomposition and electric power generation procedure.

### (Utilization of Biomass and its Waste, Etc., to be Fuel)

According to the electric power generation method of the present invention, by variously changing the semiconductor and the metal forming the composite with the semiconductor, a wide range of biomass, biomass related compounds, and their waste, or other organic/inorganic compounds, etc., can be decomposed (purified) highly efficiently and electric power can be generated simultaneously.

Of kinds of biomass, polysaccharide such as cellulose, starch, and agarose, and polymeric compounds such as protein and lignin are relatively difficult to decompose. However, in this case, the polymeric biomass compounds can more easily be decomposed when copper, nickel, or osmium is used as the metal catalyst. Otherwise, the compounds are hydrolyzed to be low molecular weight compounds in advance using an acid or an alkali and, thereafter, can further be decomposed and used for the electric power generation using the method of the present invention.

In this regard, the inventors already discloses that, when a bio-photochemical cell having a composite anode including a titanium dioxide porous thin layer, and a counter cathode for oxygen reduction disposed therein is used, these polymeric compound solutions and suspended biomass solid materials can easily be photo-decomposed by applying or irradiating the sunlight or ultraviolet light using black-light, etc. (see Non-Patent Literature 1). This is the bio-photochemical cell technology proposed by the inventors (a photo-decomposition technique). A combination of this technique and the present invention enables to provide a remarkable solution to the above mentioned problems.

According to this photo-decomposition technique as a first stage (pre-process stage), preferably, the polymeric biomass is decomposed into low-molecular compounds with photo-decomposition degree being controlled and, thereafter, the compounds are further decomposed and used in the electric power generation using the method of the present invention. The photochemical cell proposed by the inventors and the fuel cell of the present invention are combined in one, single, same cell; wherein the compounds are photo-decomposed using ultraviolet light into easy decomposable low-molecular weight compounds; and, thereafter, the compounds can be further decomposed and employed in the electric power generation using the method of the present invention.

### (Scale-Up in Size and Increase of Capacity)

The size can be increased or scale-up in size can be established using various ideas, of this composite anode composed of the three layers including; the electrode base layer/the porous semiconductor layer/the catalyst layer, for the fuel cell in the present invention.

In case, when the anode electrode base such as FTO is used whose conductivity is not so high, its resistance is increased with the increase of its size and thereby its current density is reduced. Thus, to solve this problem, preferably, some ideas are applied to increase the charge collection efficiency such as vapor-depositing on FTO a wire made of silver or copper for collecting the charges in advance before the deposition of the porous semiconductor layer.

Or alternatively, when a highly conductive metal is used for the electrode base, the size increase (scale-up in size) is facilitated. In order to increase the output, preferably, the composite anodes 2 composed of; the electrode base layer/the porous semiconductor layer/the catalyst layer, that tends to function as rate-determining step, is disposed or installed in a large quantity or in multiple units in the fuel cell 5.

As an example, the case is considered where the composite anode is used that can output 2 mW/cm² as described in a example 1 described later. Employment is assumed of the cube-shaped (tank-type) cell 5 accommodating a fuel aqueous solution of a volume of 20 cm×20 cm×20 cm (=8 L). 20 plate-shaped composite anodes whose apparent surface areas are each 20 cm×20 cm (the thickness of the anode is normally about several 10 μm and the plate shape is sufficiently thin for its thickness to be ignorable compared to its apparent surface area) are disposed at intervals each of 1 cm in the liquid phase of the cell to provide an anode area of a total of 8,000 cm². Therefore, an output of a total of 16 W/8 L can be acquired. When a module is formed by accumulating 5×5×5 cells (=125 cells) in a volume of about 1 m×1 m×1 m (1 m³), electric power of 2.0 kW/m³ can be acquired. When this module is somewhat expanded to a scale (3 kW/1.5 m³), the electric power corresponding to that consumed by one home can be provided. For example, when the energy efficiency of the power generation from glucose is 50% (that theoretically is substantially 100%), it is expected that the electric power (electricity) corresponding to that averagely consumed by one home in about a half month can be provided with about 1.5 m³ of 1-M glucose aqueous solution.

### (Metal Refining Cell)

As a one embodiment of the fuel cell reaction of the present invention (the basic invention), the fuel cell is applicable to metal refining.

In the fuel cell of the basic invention, instead of using oxygen as the electron acceptor at the counter cathode, metal ores (produced mainly as oxides), collected metals and scrap metals (referring to collected metals such as scrap iron), and oxides of metals or their salts and complex salts produced by oxidizing iron, etc., are each used as the electron acceptor under an anaerobic condition. This enables the fuel cell power generation and simultaneous acquisition of a pure metal at the cathode. As described above, not only the fuel cell power generation is enabled but also metal refining power generation of a so-to-speak three-bird-one-stone type is enabled: wherein the fuel cell decomposes and purifies waste, simultaneously generates electric power, and recycles scrap metals such as scrap iron (metal refining); without involving any melting of metal, and without requiring any energy input such as other electric power or coke. This is the embodiments as defined in claims 5 and 7.

(Production of Hydrogen Using Micro Fuel Cell at Composite Anode with No Cathode)

Furthermore, in the present invention, hydrogen can be produced using the composite anode.

Under the condition that only the composite anode of the present invention is disposed in the cell accommodating the liquid phase comprised of an aqueous solution or an aqueous suspension containing biomass as a fuel, and no cathode is used, when the liquid phase ambience is kept under an anaerobic condition, the anode acts as a micro fuel cell and the injected electrons reduce the proton in the above mentioned liquid phase comprised of the aqueous solution or the aqueous suspension and, thereby, produce hydrogen on the anode receiving the injection of the electrons from the fuel in the aqueous solution or the aqueous suspension. In this case, the composite anode configures a kind of micro cell. The “micro cell” refers to one electrode material that simultaneously has both of the functions as the anode and the cathode and, a cell having an extremely short distance between the anode side and the cathode side and having the functions is commonly referred to as “micro cell”. Thus, the micro cell has both the functions of the anode (acceptance of electrons from the fuel in the liquid) and the cathode (generation of hydrogen by donating the electrons to the protons in the liquid). However, the charges only move within the same one composite and do not flow into any external circuit. Therefore, no electric power (electricity) is acquired and, instead, the hydrogen is produced as the generated energy.

Since electric power is not suitable for storage when excess amount of electricity is generated, the hydrogen produced using the method of the present invention is preferable for storage and transportation regardless of its scale, and electric power (electricity) is easily generated by a hydrogen fuel cell and, therefore, the hydrogen is optimal for the energy demand that requires storage associated therewith.

### EXAMPLES

The present invention will be described in detail using examples thereof. However, the technical scope of the present invention is not limited to the examples. In the examples, “M” represents the mol concentration (moldm⁻³).

### Example 1

### Manufacture of Composite Anode

(1) To form the porous semiconductor layer, Ti-Nanoxide semiconductor paste (from Solaronix, T/SP (a trademark), n-type titanium dioxide TiO₂, anatase content >90%, average particle diameter: 13 nm) was prepared. A 2 cm×1 cm fluorine-doped SnO₂ conductive glass base substrate (10 Ω/cm²) (FTO) was used as the conductive electrode base. Three adhesive tape strips each having a thickness of 70 μm was stacked on each other to be used as a spacer (whose total thickness was 210 μm) on the glass base (FTO). The semiconductor paste was applied in an area of 1 cm×1 cm on this space using a squeezing method, and was dried at the room temperature, and thereafter, was sintered at 450° C. for 30 min, to form a TiO₂ porous semiconductor thin layer on the FTO.

The thickness of the thus formed TiO₂ porous semiconductor thin layer formed as described above was 20 μm and the roughness factor representing the effective surface area (the rate of the surface area of the porous material TiO₂ to its apparent surface area) was about 2,000.

(2) A conductive wire was attached to the FTO/TiO₂ layer (the anode base substrate) to form an electrode structure and, thereafter, the electrode structure was immersed in a 5 mL of 3% (vol/vol)-methanol aqueous solution containing a predetermined concentration of 2K⁺[Pt(IV)Cl₆]²⁻, and was irradiated with white light from a 500-W xenon lamp (the intensity: 500 mWcm⁻²). The hole separated following the excitation by ultraviolet light of TiO₂ disappeared due to oxidation of the methanol and, similarly, the separated electron reduced potassium chloroplatinate, and simultaneously, a platinum metal layer that was the catalyst was thereby deposited on the inner surface of the TiO₂ porous fine or micro structure. The platinum used was checked using a visible region absorption spectrum to determine the end point there by confirming that no platinum was remained in the solution so that all the platinum used was deposited. A platinum salt was used such that the atomic ratio φ of the used Pt/Ti was φ=0.34/1. In this manner, the composite anode composed of the three layers including; the electrode base FTO layer/the porous semiconductor TiO₂ layer/and the Pt catalyst layer, was manufactured. The platinum layer presented the appearance of metal luster.
(3) The composite anode was immersed in a fuel-containing aqueous solution (a 3-mL aqueous solution (pH=14) containing 1 M of glucose, 0.1 M of Na₂SO₄, and 1 M of NaOH). A counter cathode for oxygen reduction comprised of a membrane electrode assembly (MEA, whose area was 1 cm²) having a two-layered structure of; the Nafion film/the platinum-supported carbon catalyst dispersed carbon paper sheet, was disposed in a manner having one side thereof immersed in the liquid and the other side thereof appearing in a gas phase including oxygen (oxygen in the atmosphere). A Ti mesh was disposed as a collector on the atmosphere side of the MEA. Thereby, a glucose fuel cell was configured. The current (I)-voltage (V) property of the glucose fuel cell was measured. (No application of any ultraviolet light, etc., was provided to the cell when the I-V property was measured. Though application of ultraviolet light to the cell was attempted when the I-V property was measured, it was confirmed that the I-V property was not varied at all.)
(4) The results were depicted in FIG. 2. The measurement was made using a method of measuring the current value by sweeping the potential between the two electrodes, not applying the constant potential method. An I-V property curve acquired in this case might have hysteresis depending on the direction of the sweeping and, in such a case, the I-V property was determined by taking the average value of two curves acquired by the anode-direction sweeping and the cathode-direction sweeping. The ratio of Wmax acquired when the area (=output W) surrounded by the I-V curve (the average value), the voltage axis, and the current axis became its maximum, to Isc×Voc (Isc is the short-circuit current density and Voc is the open-circuited voltage) is employed as a curve factor (fill factor=FF) and the maximum power output represented by the I-V property (=Isc×Voc×FF) was acquired. Isc, Voc, FF, and the output acquired were Isc=5.0 mAcm⁻², Voc=0.79 V, and FF=0.25, and maximum power output was 0.99 mWcm⁻².

### Example 2

The glucose fuel cell I-V property of the FTO/TiO₂/Pt composite anode manufactured by varying the atomic ratio φ (=Pt/Ti) from 0.008/1 to 0.50/1 in the example 1 was measured in the same manner as in the example 1, and the maximum power output (W/cm²) was acquired from the acquired short-circuit current density (Isc/cm²), the open-circuit voltage (Voc), and the curve factor (FF). (However, the TiO₂ layer thickness was set to be 20 μm and 1-M glucose aqueous solution (pH=2) was used.) The result plotting this output against the Pt/Ti ratio is shown in Table 1 and is depicted in FIG. 1. (Table 1 collectively shows the effect of the atomic ratio φ (=Pt/Ti) on the I-V property and the maximum output.)

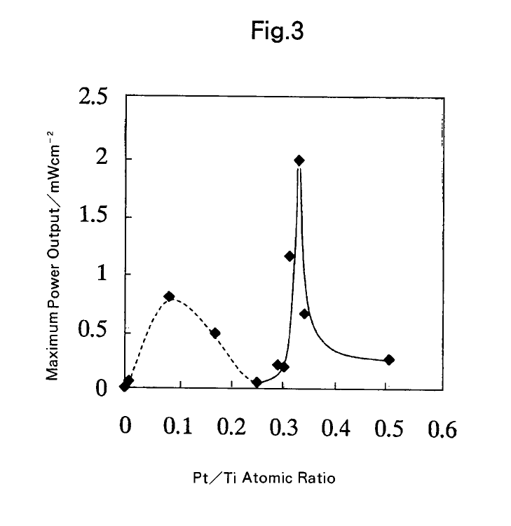

In FIG. 3, it is observed a local maximum power output value with which the curve abruptly rises in the vicinity of the atomic ratio φ (=Pt/Ti (0.33/1)), suggesting that there exists a highly active singular structure. The cathode presents an appearance of black color of the platinum black within the range of Pt/Ti ratio: Pt/Ti=0.1/1 to 0.2/1, then the cathode begins to generate its metallic luster with Pt/Ti ratio of: Pt/Ti=0.31/1 to 0.34/1 as the platinum layer becomes thicker and with it its activity is simultaneously enhanced. In calculation, at the point at which the maximum value is shown in FIG. 3, Pt deposited on the inner surface of the TiO₂ fine nano-structure forms a one-atom layer on average.

### Example 3

Nano-particles having an average diameter of 23 nm of titanium dioxide (P-25), a surface-active agent, acetylacetone, and water were sufficiently mixed with each other and the produced mixture was also kneaded sufficiently to form a paste. The paste was applied in an area of 1 cm×1 cm on a 2 cm×1 cm conductive glass (FTO) and was dried at 100° C. These steps were repeated and the paste was finally sintered at 450° C. for 30 min to acquire an FTO/TiO₂ super-porous layer (having a thickness of about 20 μm). This working electrode had an effective surface area about 2,000 times as large as its apparent surface area. Pt was deposited on this anode base substrate in the same manner as in the example 1 to acquire a composite anode having the atomic ratio φ(Pt/TiO₂ (0.31/1)). Using this composite anode, the glucose fuel cell property was measured following the same way as in the example 1 and an equivalent power generation property was acquired whose conditions were same as those in FIG. 3.

### Example 4

The experiment was conducted in the same way as in the example 1 except that a titanium dioxide thin layer having a thickness of 10 μm was used as the porous semiconductor thin layer and light was applied from the side of the FTO for the photo-deposition of platinum that was the catalyst, and the glucose fuel cell property was measured similarly to acquire Isc, Voc, FF, and the maximum power output that were Isc=3.4 mA/cm², Voc=0.62 V, FF=0.24, and maximum power output was 0.51 mW/cm².

### Example 5

As further shown in Table 2, at the atomic ratio φ (=Pt/Ti) of 0.31/1 or 0.33/1, an experiment was conducted in the same manner as was in the example 1 varying the thickness of the porous semiconductor thin layer, pH, and the glucose concentration and, its result is shown in Table 2.

(Table 2 collectively shows the effects of the thickness of the TiO₂ layer, the solution pH, and the glucose concentration.)

### Example 6

A composite anode (FTO/a porous titanium dioxide thin layer (layer thickness: 10 μm)/a metal layer: 1 cm²) was manufactured using Ni, Cu, or Os that was each far less expensive than a precious metal as the metal catalyst, and the decomposition and power generation properties were studier for polymeric biomass compounds and glucose. The result thereof was exemplified in Table 3. It can be seen that even indecomposable polymeric biomass can easily be decomposed and used for the power generation. (In table 3, the atomic ratio φ (=M/Ti) was set to be 0.3 (Ni/Ti), 158 (Cu/Ti), and 0.18 (Os/Ti).)

### Example 7

A composite anode having the atomic ratio φ (=Pt/Ti 0.33)) was manufactured using Pt metal as the catalyst, and how many electrons of the 24 electrons of glucose were usable (available) was studied using a 0.01-mM glucose aqueous solution (5 mL). A charge of 0.064 C flowed after five hours and this corresponded to a flow of 13.3 electrons on average of the 24 electrons of one glucose molecule (55% used). Another composite anode of (Cu/Ti=158 atomic ratio) was manufactured using Cu metal as the catalyst and the same measurement was conducted using a 0.1-mM glucose aqueous solution (5 mL). A charge of 0.801 C flowed after five hours and it was confirmed that this corresponded to a flow of 16.6 electrons on average of the 24 electrons of one glucose molecule (69% used).

### Example 8

A composite anode having the atomic ratio φ (=Pt/Ti (0.34)) and the TiO₂ layer (thickness: 10 μm) was manufactured using Pt metal as the catalyst, and, using a 1-M glucose aqueous solution (5 mL), setting an anaerobic ambience in the cell, and without using any cathode, hydrogen was produced. The hydrogen was qualitatively and quantitatively analyzed using a gas chromatography. Hydrogen of 182 μL was acquired in one hour. This generated amount was larger by one digit than that acquired when a Pt plate deposited thereon with Pt black was used instead of the composite anode.

### Example 9

In the example 1, an experiment was conducted in the same manner as in the example 1 except that the thickness of the porous TiO₂ thin layer was set to be 10 μm. With a cell whose cathode MEA area was set to be 1 cm², Isc, Voc, FF, and the maximum power output were acquired that were Isc=1.4 mA/cm², Voc=0.85 V, FF=0.24, and maximum power output was 0.29 mW/cm². In contrast, with a cell whose cathode MEA area was increased to 4 cm², that was four times as large as its original area, Isc, Voc, FF, and the maximum power output were acquired that were Isc=4.3 mA/cm², Voc=1.6 V, FF=0.25, and the maximum power output was 1.72 mW/cm². When the MEA of the cathode electrode was increased in size to that four times as large as its original size, the maximum power output became 5.9 times as high as its original value.

### Example 10

In the example 1, a titanium plate (whose thickness was 0.3 mm) was used instead of FTO as the base electrode and titanium dioxide layers (each having a thickness of 10 μm) were manufactured on both sides of the titanium plate using a titanium dioxide paste of an amount twice as much as the previously used. In the same way as in the example 1, a Pt layer was photo-deposited and the power generation property was similarly studied using glucose. As a result, Isc, Voc, FF, and the maximum power output were acquired that were Isc=1.6 mA/cm², Voc=1.6 V. FF=0.25, and maximum power output was 0.64 mW/cm².

### Example 11

In the example 1, the power generation property was studied in the same manner as in the example 1 except that the TiO² layer thickness was set to be 10 μm and a liquid of 5 mL was used that was prepared by suspending at a rate of 0.2 g of colored leaves of Lagerstroemia indica (crape myrtle) were pulverized using a homogenizer, in water of 20 mL. As a result, Isc, Voc, FF, and the maximum power output were acquired that were Isc=0.32 mA/cm², Voc=0.12 V, FF=0.25, and maximum power output was 9.6 μW/cm².

TABLE 1

| | | | | Maximum | |
|---|---|---|---|---|---|
| Atomic | | | | Power | |
| Ratio/ | Isc/ | Voc/ | | Output/ | |
| Pt/Ti | mAcm⁻² | V | FF | mWcm⁻² | Remark |
| 0 | 0 | 0 | 0 | 0 | |
| 0.008 | 0.20 | 0.88 | 0.25 | 0.04 | |
| 0.83 | 2.0 | 1.04 | 0.38 | 0.78 | |
| 0.17 | 2.4 | 0.62 | 0.32 | 0.47 | |
| 0.25 | 1.0 | 0.42 | 0.12 | 0.05 | |
| 0.29 | 1.9 | 0.45 | 0.25 | 0.21 | |
| 0.30 | 1.8 | 0.42 | 0.25 | 0.19 | |
| 0.31 | 5.6 | 0.82 | 0.25 | 1.15 | Metal luster |
| 0.32 | 2.3 | 1.02 | 0.55 | 1.29 | Metal luster |
| 0.33 | 5.1 | 1.29 | 0.30 | 1.97 | Metal luster |
| 0.34 | 5.0 | 0.79 | 0.25 | 0.99 | Metal luster |
| 0.42 | 0.82 | 0.53 | 0.25 | 0.11 | |
| 0.50 | 2.7 | 0.54 | 0.18 | 0.26 | Partial |
| | | | | | peeling off of |
| | | | | | the TiO₂ layer |
| (Pt plate | 0.08 | 0.70 | 0.01 | 0.04 | |
| only) | | | | | |

TABLE 2

| | | | | | | | Maximum | |
|---|---|---|---|---|---|---|---|---|
| TiO₂ layer | Pt/Ti | | | Isc/ | | | Power | |
| Thickness/ | Atomic | | Glucose | mA | | | Output | |
| μm | Ratio | pH | Concentration/M | cm⁻² | Voc/V | FF | mWcm⁻² | Result |
| 5 | 0.31 | 14.0 | 1.0 | 0.44 | 0.50 | 0.23 | 0.051 | The |
| 10 | | | | 3.4 | 0.62 | 0.24 | 0.51 | TiO₂ |
| 20 | | | | 5.3 | 0.77 | 0.27 | 1.08 | layer |
| 30 | | | | TiO₂ layer tends to peel off. | | | | thickness |
| | | | | | | | | effect |
| | | | | | | | | was |
| | | | | | | | | high. |
| 20 | 0.33 | 2.1 | 1.0 | 0.2 | 0.04 | 0.25 | 0.002 | The pH |
| | | 8.4 | | 0.6 | 0.05 | 0.25 | 0.008 | effect |
| | | 11.8 | | 2.2 | 0.67 | 0.25 | 0.37 | was |
| | | 14.0 | | 5.1 | 1.29 | 0.30 | 1.97 | high. |
| | 0.31 | 14.0 | 0.01 | 2.5 | 0.70 | 0.25 | 0.44 | The |
| | | | 0.1 | 2.6 | 0.74 | 0.25 | 0.48 | glucose |
| | | | 1.0 | 5.3 | 0.77 | 0.27 | 1.10 | effect |
| | | | | | | | | is not |
| | | | | | | | | so |
| | | | | | | | | high. |

TABLE 3

| Biomass | | | | | | |
|---|---|---|---|---|---|---|
| (Concentration/mM | | | Isc/ | | | Output/ |
| repeating unit) | Metal | pH | μAcm⁻² | Voc/V | FF | μWcm⁻² |
| CMC (carboxymethyl | Ni | 3 | 510 | 0.45 | 0.24 | 55 |
| cellulose) (10) | Cu | 3 | 740 | 0.38 | 0.25 | 70 |
| | Oₛ | 14 | 460 | 0.38 | 0.25 | 44 |
| Soluble Starch (10) | Ni | 3 | 870 | 0.33 | 0.24 | 69 |
| Glucose (1000) | Ni | 7 | 170 | 0.55 | 0.23 | 22 |
| | Cu | 14 | 850 | 0.69 | 0.25 | 147 |
| | Oₛ | 14 | 590 | 0.47 | 0.25 | 69 |
| Lignin Sulfonic Acid | Ni | 7 | 270 | 0.49 | 0.23 | 30 |
| (1) | Cu | 7 | 320 | 0.26 | 0.25 | 21 |

### INDUSTRIAL APPLICABILITY

According to the present invention, the composite anode composed of; the anode electrode base layer/the porous semiconductor thin layer/the metal catalyst layer is used together with the cathode electrode for oxygen reduction and, thereby, biomass, its waste, or other organic/inorganic compounds as the direct fuel can be highly efficiently decomposed and purified through the fuel cell reaction without applying or irradiating any light thereto, and electric power (electricity) can be generated.

According to the present invention, metal refining of a soft-path and energy-saving type is realized that requires no other energy such as application of light. According to the present invention, biomass, its waste, or other organic/inorganic compounds can be used as fuel and, thereby, a near-future sustainable energy system can be constructed and the industrial applicability thereof must be said to be significant.

Furthermore, in the present invention, when no counter cathode is used or installed and the anaerobic condition is maintained in the cell and, thereby, micro cells are formed in the composite anode and this enables production of hydrogen. Since hydrogen can easily be converted into electric power using the hydrogen fuel cell, and is an energy resource easily stored and transported, and, therefore, has a high utility value as a sustainable energy resource capable of being directly produced from biomass.

1. A method for decomposing and purifying a fuel and generating electric power through a fuel cell reaction of the fuel without applying external energy, the method comprising:
(a) providing a composite anode composed of three layers including; a conductive electrode base layer/a porous semiconductor layer/a catalyst layer, the porous semiconductor layer being deposited on the conductive electrode base layer, the catalyst layer made of a metal, a metal oxide, or a semiconductor being formed on the semiconductor layer;
(b) immersing the composite anode in, or bringing the composite anode into contact with, a liquid phase comprised of an aqueous solution or an aqueous suspension that contains as the fuel at least one of or a mixture of biomass, biomass waste, and organic/inorganic compounds;
(c) disposing a counter cathode for oxygen reduction in the liquid phase comprised of the aqueous solution or the aqueous suspension or in an liquid phase/gas phase interface where the liquid phase is in contact with a gas phase; and
(d) supplying oxygen into, or causing oxygen to coexist in, the liquid phase where the cathode is disposed or the liquid phase/gas phase interface, thereby inducing the fuel cell reaction on the cathode, decomposing and purifying the fuel, generating electric power through the fuel cell reaction without applying external energy thereto.

2. The method of claim 1, wherein
atomic ratio of metal forming the catalyst layer to metal forming the semiconductor layer of the composite anode is 0.01/1 to 1,000/1.

3. A fuel cell comprising a composite anode and a counter cathode for oxygen reduction and decomposing and purifying a fuel and generating electric power through a fuel cell reaction without applying external energy thereto, wherein
(a) the composite anode is composed of three layers including; a conductive electrode base layer/a porous semiconductor layer/a catalyst layer, the porous semiconductor layer being deposited on the conductive electrode base layer, the catalyst layer made of a metal, a metal oxide, or a semiconductor being formed on the semiconductor layer, wherein
(b) the composite anode is immersed in, or in contact with, a liquid phase comprised of an aqueous solution or an aqueous suspension that contains as the fuel at least one of or a mixture of biomass, biomass waste, and organic/inorganic compounds, wherein
(c) the counter cathode for oxygen reduction is disposed in the liquid phase comprised of the aqueous solution or the aqueous suspension or in an liquid phase/gas phase interface where the liquid phase is in contact with a gas phase, and wherein
(d) the fuel cell is configured to supply oxygen into, or cause oxygen to coexist, in the liquid phase or the liquid phase/gas phase interface where the cathode is disposed, thereby inducing the fuel cell reaction on the cathode, decomposing and purifying the fuel and generating electric power through the fuel cell reaction without applying external energy thereto.

4. The fuel cell for claim 3, wherein
atomic ratio of metal forming the catalyst layer to metal forming the semiconductor layer of the composite anode is 0.01/1 to 1,000/1.

5. A method for executing fuel-cell power generation without applying external energy thereto and simultaneously producing a pure metal using a cathode, the method comprising:
(a) providing a composite anode composed of three layers including; a conductive electrode base layer/a porous semiconductor layer/a catalyst layer, the porous semiconductor layer being deposited on the conductive electrode base layer, the catalyst layer made of a metal, a metal oxide, or a semiconductor being formed on the semiconductor layer;
(b) immersing the composite anode in, or bringing the composite anode into contact with, a liquid phase comprised of an aqueous solution or an aqueous suspension that contains as the fuel at least one of or a mixture of biomass, biomass waste, and organic/inorganic compounds;
(c) disposing a counter cathode for oxygen reduction in the liquid phase comprised of the aqueous solution or the aqueous suspension or in an liquid phase/gas phase interface where the liquid phase is in contact with a gas phase; and
(d) maintaining an ambience in the liquid phase where the composite anode is disposed, or the liquid phase/gas phase interface to be under an anaerobic condition, causing an oxide, a salt, and a complex of a metal produced by oxidizing a metal ore, a collected metal, or a scrap metal to co-exist as an electron acceptor in the liquid phase or the liquid phase/gas phase interface, and thereby inducing the fuel cell reaction on the cathode, producing a pure metal and generating electric power without applying external energy thereto.

6. The method of claim 5, wherein
atomic ratio of metal forming the catalyst layer to metal forming the semiconductor layer of the composite anode is 0.01/1 to 1,000/1.

7. A fuel cell comprising a composite anode and a counter cathode for oxygen reduction, executing fuel-cell power generation without applying external energy thereto, and simultaneously producing a pure metal at the cathode, wherein
(a) the composite anode is composed of three layers including; a conductive electrode base layer/a porous semiconductor layer/a catalyst layer, the porous semiconductor layer being deposited on the conductive electrode base layer, the catalyst layer made of a metal, a metal oxide, or a semiconductor being formed on the semiconductor layer, wherein
(b) the composite anode is immersed in, or in contact with, a liquid phase comprised of an aqueous solution or an aqueous suspension that contains as the fuel at least one of or a mixture of biomass, biomass waste, and organic/inorganic compounds, wherein
(c) the counter cathode for oxygen reduction is disposed in the liquid phase comprised of the aqueous solution or the aqueous suspension or in a liquid phase/gas phase interface where the liquid phase is in contact with a gas phase, and wherein
(d) an ambience in the liquid phase or the liquid phase/gas phase interface where the cathode is disposed is maintained to be under an anaerobic condition, and an oxide, a salt, or a complex of a metal produced by oxidizing a metal ore, a collected metal, or a scrap metal, is caused to co-exist as an electron acceptor in the liquid phase or the liquid phase/gas phase interface, and thereby the fuel cell reaction is induced on the cathode, and producing the pure metal at the cathode and generating electric power without applying external energy thereto.

8. The fuel cell of claim 7, wherein
atomic ratio of metal forming the catalyst layer to metal forming the semiconductor layer of the composite anode is 0.01/1 to 1,000/1.

9. A method using a composite anode, of executing micro-fuel-cell electric power generation on the anode and simultaneously producing hydrogen on the anode, without applying external energy thereto, wherein
(a) the composite anode is composed of three layers including; a conductive electrode base layer/a porous semiconductor layer/and a catalyst layer, the porous semiconductor layer being deposited on the conductive electrode base layer, the catalyst layer made of a metal, a metal oxide, or a semiconductor, being formed on the semiconductor layer, wherein
(b) the composite anode is immersed in, or in contact with, a liquid phase comprised of an aqueous solution or an aqueous suspension that contains as the fuel at least one of or a mixture of biomass, biomass waste, and organic/inorganic compounds, and wherein
(c) an ambience in the liquid phase where the anode is disposed to be under an anaerobic condition, and the anode acts as a micro cell and, on the anode electrons being injected from the fuel in the liquid phase comprised of the aqueous solution or the aqueous suspension, and the injected electrons are being delivered to protons in the liquid phase comprised of the aqueous solution or the aqueous suspension, thereby producing hydrogen, and generating electric power without applying external energy thereto.

10. The micro fuel cell power generation method of claim 9, wherein
atomic ratio of metal forming the catalyst layer to metal forming the semiconductor layer of the composite anode is 0.01/1 to 1,000/1.

11. A micro fuel cell comprising a composite anode, executing micro-fuel-cell electric power generation on the anode without applying external energy thereto, and simultaneously producing hydrogen on the anode, wherein
(a) the composite anode is composed of three layers including; a conductive electrode base layer/a porous semiconductor layer/a catalyst layer, the porous semiconductor layer being deposited on the conductive electrode base layer, the catalyst layer made of a metal, a metal oxide, or a semiconductor being formed on the semiconductor layer, wherein
(b) the composite anode is immersed in, or in contact with, a liquid phase comprised of an aqueous solution or an aqueous suspension that contains as fuel at least one of or a mixture of biomass, biomass waste, and organic/inorganic compounds, and wherein
(c) an ambience in the liquid phase where the composite anode is disposed is maintained to be under an anaerobic condition, and the anode acts as a micro cell and, on the anode electrons being injected from the fuel in the liquid phase comprised of the aqueous solution or the aqueous suspension, and the injected electrons are being delivered to protons in the liquid phase comprised of the aqueous solution or the aqueous suspension, thereby producing hydrogen, and generating electric power simultaneously without applying external energy thereto.

12. The micro fuel cell of claim 11, wherein
atomic ratio of metal forming the catalyst layer to metal forming the semiconductor layer of the composite anode is 0.01/1 to 1,000/1.
